(19) United States
(12) Patent Application Publication
(10) Pub. No.: US 2007/0181489 A1
(43) Pub. Date: Aug. 9, 2007

(54) Straining device

(76) Inventor: Elizabeth Ka Ying Lee, Hong Kong (CN)

Correspondence Address: HESLIN ROTHENBERG FARLEY & MESITI PC, 5 COLUMBIA CIRCLE, ALBANY, NY, 12203, US

(21) Appl. No.: 11/350,182

(22) Filed: Feb. 8, 2006

(51) Int. Cl. B01D 29/00

(52) U.S. Cl. 210/473; 99/485; 99/646 LS

(57) ABSTRACT

A collapsible food-straining device made of a resilient material is disclosed. When in use, the strainer is in an unstable extended configuration. When not in use, the strainer can be easily stored in drawers or small spaces in a contracted configuration.

### FIELD OF THE INVENTION

The present invention relates to improved or alternative devices useful for straining liquid from foodstuffs. More particularly the invention relates to strainers that are capable of collapsing for easy storage.

### BACKGROUND

Devices for straining liquid from foodstuffs are well known. Colanders are examples of utensils that are useful in this regard, and are commonly found in both household and commercial kitchens.

The majority of strainers are relatively uncomplicated devices, with most simply comprising an apertured bowl and a handle (although some are provided with ridges for balancing the strainer on the rim of a larger contained, rather than having a handle). Strainers are often made from a heat-resistant plastic, making them both lightweight and useful for straining hot liquid from foodstuffs. Alternatively they can be made from lightweight metal, which makes them last longer and provides them with a higher tolerance when subjected to high heat.

While strainers should be of a size large enough to hold a reasonable amount of food, they also need to be compact enough to allow for convenient storage.

A number of manufacturers have produced collapsible colanders, which can be folded or manipulated to permit easier storage. One common model utilises a bowl-shaped sliding leaf arrangement, similar to the adjustable aperture arrangement on a camera. When not in use, the leaves slide behind each other so that the colander retracts to the size of a small bowl. Telescopic colanders are also known in the art. These comprise a frame with telescope-like walls that can extend and retract as desired. A perforated base is attached to the last of the telescopic extensions, so that liquid can exit the colander when in use. The base and telescopic walls can retract when not in use, allowing the colander to be stored with ease. One disadvantage with a telescopic colander is that the number of moving parts means that the colander is susceptible to breakage.

It is an object of the present invention to provide an improved or alternative colander to those known in the art.

### SUMMARY OF THE INVENTION

In one aspect the invention broadly comprises a strainer for straining liquid from foodstuffs comprising a frame and a straining portion, the straining portion made of a resilient material, and said straining portion having a stable contracted configuration and an unstable extended configuration.

Preferably the straining portion is made from a thermoplastic rubber or silicon.

In a preferred embodiment, the straining portion is made by compression moulding, or by injection moulding.

Preferably the straining portion comprises intersecting radial and circumferential structures. In a preferred embodiment, the cross section of the radial and/or circumferential structures is either substantially round or substantially oval.

In a particularly preferred embodiment, the straining portion further comprises a base portion that is substantially planar when the straining portion is in its stable contracted configuration.

The invention may also broadly be said to consist in any alternative combination of features as described or shown in the accompanying drawings. Known equivalents of these features not expressly set out are nevertheless deemed to be included.

### DETAILED DESCRIPTION OF THE INVENTION

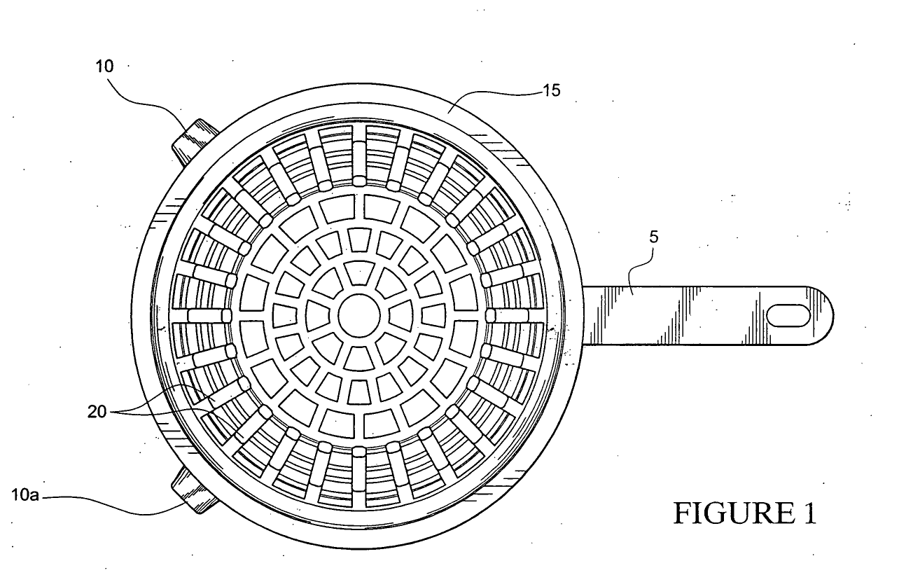

FIG. 1 is a view of the top of one embodiment of the invention.

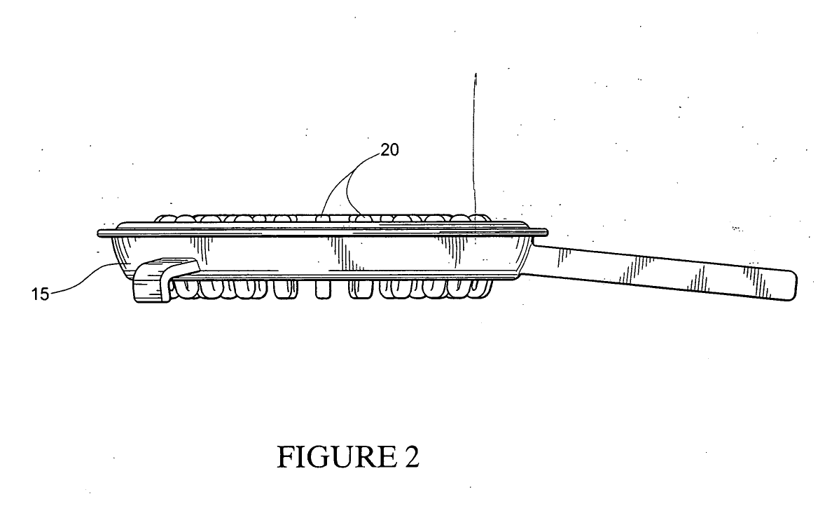

FIG. 2 is a side elevation of the strainer shown in FIG. 1. From this view it can be seen that the strainer is in a stable contracted configuration.

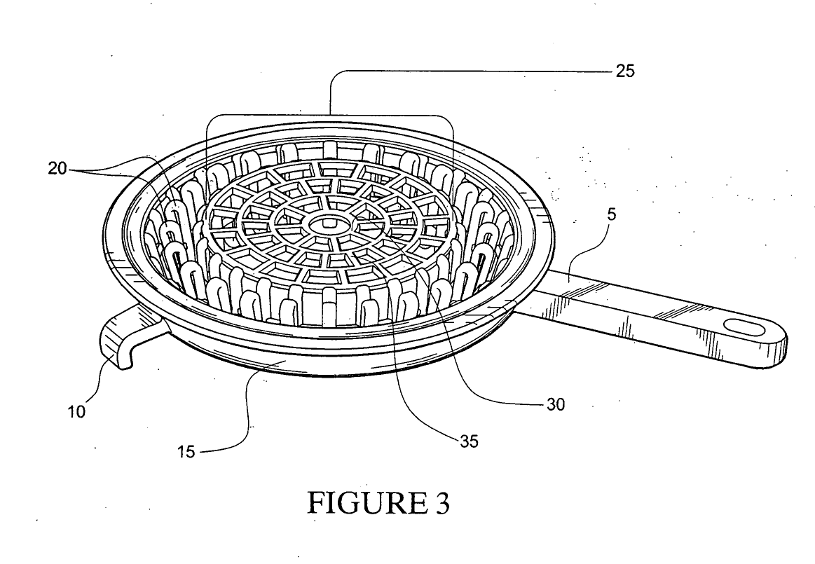

FIG. 3 is a perspective view of one embodiment of the invention, showing the strainer in the stable contracted configuration.

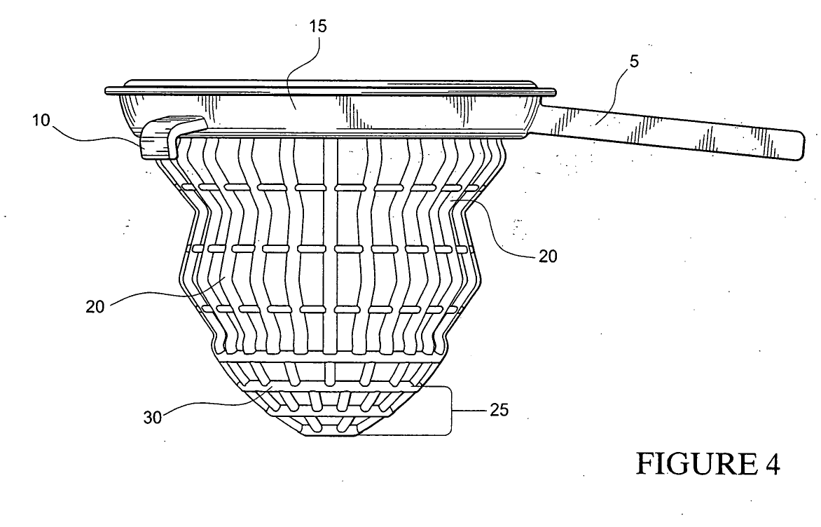

FIG. 4 is a side elevation of an embodiment on the invention, showing the strainer in its unstable extended configuration.

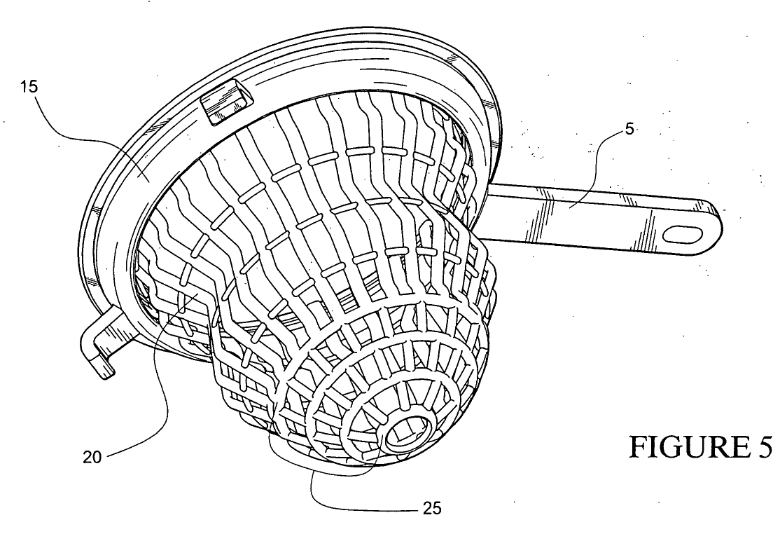

FIG. 5 is a perspective view of an embodiment of the invention, also showing the strainer in an unstable extended configuration.

FIG. 1 is a top view of one embodiment of the invention. This particular embodiment includes a handle (5) and two flanges (10, 10a) formed on the rim (15). When resting the strainer over a larger container (such as a pot or bowl), the handle (5) and flanges (10, 10a) serve to balance the strainer on top of the container and hold it in place. In this particular embodiment, there are a number of contracted structural members (20) extending radially from the center of the strainer. When pressure is exerted on the inside of the straining portion (e.g. when foodstuffs to be strained are placed in the strainer), these members extend and transform the shape of the strainer (as shown in FIGS. 4 and 5).

FIG. 2 is a side elevation of the same embodiment of the invention, showing the strainer in its contracted stable configuration. In this Figure the contracted structural members (20) can be seen extending from behind the rim (5).

This stable contracted configuration is largely the result of the method of manufacture of the strainer. A resilient material, such as silicon or a suitable thermoplastic rubber, is moulded into the appropriate shape, with preferred methods of moulding being compression moulding and injection moulding. The resulting strainer, while flexible enough to change shape easily, should be at its most stable configuration when in its “non use” contracted configuration.

FIG. 3 is a perspective view of the strainer in its stable configuration. This particular embodiment includes a base portion (25) that is shaped so as to provide a substantially flat platform on which to place foodstuffs for straining. The base portion in this embodiment is made up of circumferential members (30) and radial members (35). When in use, the base portion undergoes less deformation than the other areas of the straining portion, such as the extending structural members (20).

FIG. 4 shows an embodiment of the invention in its unstable extended configuration. Under normal conditions, the strainer should deform and adopt this configuration when enough pressure is exerted on the top surface of the strainer when it is in its stable contracted configuration. Usually this would involve placing an appropriate quantity of food on the surface of the strainer, so that the temporary deformation can take place.

It can be seen in this figure that the structural members (20) that were contracted in FIG. 2 have now extended, increasing the effective volume of the container so that it can function as a container. In this embodiment, the base portion (25) is also slightly deformed, but less so than the extended structural members (20). The presence of the base portion makes it harder for foodstuffs to get caught in the contracting structural members when the strainer is being emptied and is returning to its stable configuration.

FIG. 5 is a perspective view of the strainer in its unstable extended configuration. In this particular embodiment there is a noticeable increase in capacity when the strainer is in its extended unstable configuration.

Reference is made throughout this specification to the strainer having a stable and unstable configuration. In the stable (contracted) configuration, the strainer is under little or no stress, and this is the configuration that the strainer will eventually return to if deformed. The unstable configuration referred to in this application is the “in use” configuration. Without some sort of force or pressure to deform the strainer (such as the weight of foodstuffs placed in the strainer), the strainer will ideally revert back to its stable “non-use” configuration.

Persons skilled in the art will appreciate that the ability for the strainer to have its stable and unstable configuration will be dependent on the materials used, and the method of manufacture of the strainer. Suitable materials will, once moulded, retain a “memory” of their stable moulded shape. The materials will also need to be able to withstand relatively high temperatures, without undergoing permanent deformation. As noted above, particularly preferred materials are silicon or thermoplastic rubbers. A skilled reader would also appreciate that the circumferential and radial structures making up the strainer would ideally have circular or oval cross sections, so as to increase their durability if cut or damaged in any way.

It will also be appreciated by a skilled reader that the straining portion of the invention does not have to be made up of intersecting structural members. For example, it is envisaged that any material that is permeable to liquids can be used in the invention, as long as the properties of the material allow it to form a strainer with a stable contracted configuration and an unstable extended configuration.

An advantage of the present invention is that the strainer can be easily stored in drawers or small spaces when not in use. Furthermore, preferred materials result in the strainer being dishwasher-friendly.

The above describes some preferred embodiments of the present invention and indicates several possible modifications, but it will be appreciated by those skilled in the art that other modifications can be made without departing from the scope of the invention.

What I claim is:

1. A strainer for straining liquid from foodstuffs comprising a frame and a straining portion, the straining portion made of a resilient material, and said straining portion having a stable contracted configuration and an unstable extended configuration.

2. A strainer according to claim 1 wherein the straining portion is made from a thermoplastic rubber or silicon.

3. A strainer according to claim 1 wherein the straining portion is made by compression moulding.

4. A strainer according to claim 1 wherein the straining portion is made by injection moulding.

5. A strainer according to claim 1 wherein the straining portion comprises intersecting radial and circumferential structures.

6. A strainer according to claim 5 wherein the cross section of the radial and/or circumferential structures is either substantially round or substantially oval.

7. A strainer according to claim 1 wherein the straining portion further comprises a base portion that is substantially planar when the straining portion is in its stable contracted configuration.

8. A strainer according to claim 2 wherein the straining portion is made by compression moulding.

9. A strainer according to claim 2 wherein the straining portion is made by injection moulding.

10. A strainer according to claim 2 wherein the straining portion comprises intersecting radial and circumferential structures.

11. A strainer according to claim 10 wherein the cross section of the radial and/or circumferential structures is either substantially round or substantially oval.

12. A strainer according to claim 2 wherein the straining portion further comprises a base portion that is substantially planar when the straining portion is in its stable contracted configuration.
